(19) United States
(12) Patent Application Publication
(10) Pub. No.: US 2005/0109398 A1
(43) Pub. Date: May 26, 2005

(54) Combination fill and safety valve

(76) Inventor: Chao Yang Huang, Shanghai (CN)

Correspondence Address: Norma E. Henderson, Esq.;Hinckley, Allen & Snyder LLP, 2nd floor, 43 North Main Street, Concord, NH, 03301-4934, US

(21) Appl. No.: 10/720,368

(22) Filed: Nov. 24, 2003

(51) Int. Cl. F16K 21/00

(52) U.S. Cl. 137/223

(57) ABSTRACT

A combination fill and safety valve has a cap that accepts and incorporates an advanced safety valve with an incorporated inflation/deflation valve stopper replacement. In a preferred embodiment, the valve is comprised of a valve cup and a modified screw cap with an integrated advanced safety valve/stopper that is inserted into the hole in the valve cup and held in place by the modified screw cap. In a preferred embodiment, the advanced safety valve/stopper is inserted into the fill valve hole in the screw valve chassis of the valve cup. The advanced safety valve/stopper fits snugly against the lip of the valve chassis in order to provide an airtight seal when the screw cap is tightened. The advanced safety valve/stopper also comprises a safety cap that fits snugly into the safety valve hole. The modified screw cap has a hole through which the safety cap protrudes when the fill valve is closed, in order to allow opening and closing of the safety valve. To initiate operation as an inflation/deflation valve, the modified safety cap is unscrewed and the advanced safety valve/stopper is removed from the valve hole in the valve cup, thereby allowing air to be freely passed into and/or out of the inflatable through the valve hole. To initiate operation as a safety valve, the cap of the advanced safety/valve stopper is removed from the safety valve hole through which air enters and/or is made to exit the inflatable through an interior check valve.

### FIELD OF THE INVENTION

The invention relates to air valves for inflatable products and, in particular, to an air valve combining rapid inflation/deflation and safety functions.

### BACKGROUND

Today's large inflatable products, such as swimming pools, furniture, airbeds, and inflatable pool and sports equipment, typically have two valves—an inflation/deflation valve for rapid inflation and deflation of the product and an inflation/safety valve that allows air to be added to the inflatable but requires adjustment of an interior check valve to allow deflation.

FIG. 1 depicts a prior art inflation/deflation valve. Assembled prior art inflation/deflation valve 100 is comprised of three separate components: valve cup 110, stopper 120, and cap 130. Stopper 120 is typically made of rubber and is placed into valve hole 140 of screw valve chassis 150 in the center of valve cup 110 in order to prevent air from escaping. Cap 130 is typically plastic and screws onto screw valve chassis 150 in order to hold stopper 120 firmly in place. Closure of prior art inflation/deflation valve 100 is therefore a two-step process. Not infrequently, air may escape the inflatable product during closure due to the difficulty of holding the stopper firmly in place while installing the cap.

FIG. 2 depicts a prior art inflation/safety valve. Prior art inflation/safety valve 200 is comprised of two integrally attached components: safety valve cup 210 and safety cap 220. Safety cap 220 attaches to safety valve cup 210 via flexible stem 230 which bends to allow safety cap 220 to be inserted into safety valve hole 240. Safety valve 200 is an industry standard design, allowing air entry into the inflatable but requiring adjustment of an interior check valve (not shown) for deflation.

The current two-valve scheme has a number of disadvantages. Manufacturing and installation of two valves rather than one increases manufacturing time and cost. The presence of two valves also gives the inflatable product two somewhat weak points where the valves are sealed into the main skin of the inflatable product. In practice, the inflation/deflation and inflation/safety valves are often located side by side, potentially creating a particularly weak section in the wall of the inflatable product. Further, sealing the current inflation/deflation valve inconveniently requires two steps (insertion of the stopper, followed by screwing on the cap) and presents the probability of air escape during the closure process.

What has been needed, therefore, is an air valve that combines both the inflation/deflation and safety valve functions, eliminating the need to have two separate valves for performing the required range of inflation and deflation functions. What has been further needed is an inflation/deflation valve that may be securely sealed in one step with minimal air escape.

### OBJECTS OF THE INVENTION

Accordingly, an object of the present invention is to provide an air valve that combines the inflation/deflation and safety valve functions of the two prior art valves. A further object of the present invention is to provide a valve that produces reduced manufacturing and installation costs over use of the two prior art valves. Another object of the present invention is to provide a more robust inflatable product. Other objects of the present invention are to reduce the possibility of air escape from the inflatable during closure of the inflation/deflation valve and to minimize the number of steps required to seal the inflation/deflation valve.

### SUMMARY

These and other objectives are met by the present invention, which is a combination fill and safety valve that eliminates the need for separate rapid inflation/deflation and safety valves in inflatable products. The combination fill and safety valve of the present invention is an advanced screw valve that has a one-piece cap and modified safety valve having an incorporated inflation/deflation valve stopper replacement. In one embodiment of the present invention, the combination fill and safety valve is comprised of a valve cup and a modified screw cap integrally incorporating an advanced safety valve/stopper that inserts into the hole in the valve cup and is held in place by means of the modified screw cap.

In a preferred embodiment, the fill valve hole in the screw valve chassis of the valve cup receives the stopper portion of the advanced safety valve/stopper. A seal portion of the advanced safety valve/stopper fits snugly against the lip of the valve chassis in order to provide an airtight seal when the screw cap is tightened. The advanced safety valve/stopper further has a safety cap, attached by a flexible stem to the safety valve hole, into which the safety cap fits snugly. The modified screw cap is integrally attached to the advanced safety valve/stopper and has a screw cap hole through which the safety cap and stem protrude in order to allow for opening and closing of the safety valve. When used as a safety valve, air enters and/or is made to exit the inflatable through an interior check valve.

The valve of the present invention has two modes of operation, as an inflation/deflation valve and as an inflation/safety valve. In the unsealed state, the valve of the present invention may be operated as a standard inflation/deflation valve. To initiate operation as an inflation/deflation valve, the modified safety cap is unscrewed and the integrally attached advanced safety valve/stopper is removed from the valve hole in the valve cup, thereby allowing air to be freely passed into and/or out of the inflatable through the valve hole using any method and or mechanism known in the art. The cap and integrally attached safety valve/stopper are then replaced to cease inflation/deflation valve operation. In the sealed state, the valve of the present invention may be operated as a standard safety valve. To initiate operation as an inflation/safety valve, the cap of the advanced safety/valve stopper is removed from the safety valve hole, thereby allowing air to be blown into the inflatable or, with adjustment of the safety valve interior check valve, forced out of the inflatable.

### BRIEF DESCRIPTION OF THE DRAWINGS

FIG. 1 is a prior art inflation/deflation valve;

FIG. 2 is a prior art inflation/safety valve;

FIG. 3 is an embodiment of the combination fill and safety valve of the present invention;

FIG. 4 is an exploded top view of an embodiment of the combination fill and safety valve of the present invention;

FIG. 5 is an exploded bottom view of an embodiment of the combination fill and safety valve of the present invention; and

FIG. 6 is a cross section of an embodiment of the combination fill and safety valve of the present invention in the closed state.

### DETAILED DESCRIPTION

The present invention is an advanced screw valve that is designed to eliminate the need for separate rapid inflation/deflation and safety valves in inflatable products, as well as the need to perform two steps to close an inflation/deflation valve. The combination fill and safety valve of the present invention has a screw valve assembly that replaces three parts found in the prior art separate inflation/deflation and safety valves. The two-step installation of the stopper and screw cap found in the prior art inflation/deflation valve is thereby replaced by a one-step operation. The advanced valve of the present invention functions as a rapid inflation and deflation port while also possessing the ability to inflate the product via the incorporated safety valve. It is suitable for use in any style of inflatable product including, but not limited to pools, furniture, airbeds, and inflatable pool and sports equipment.

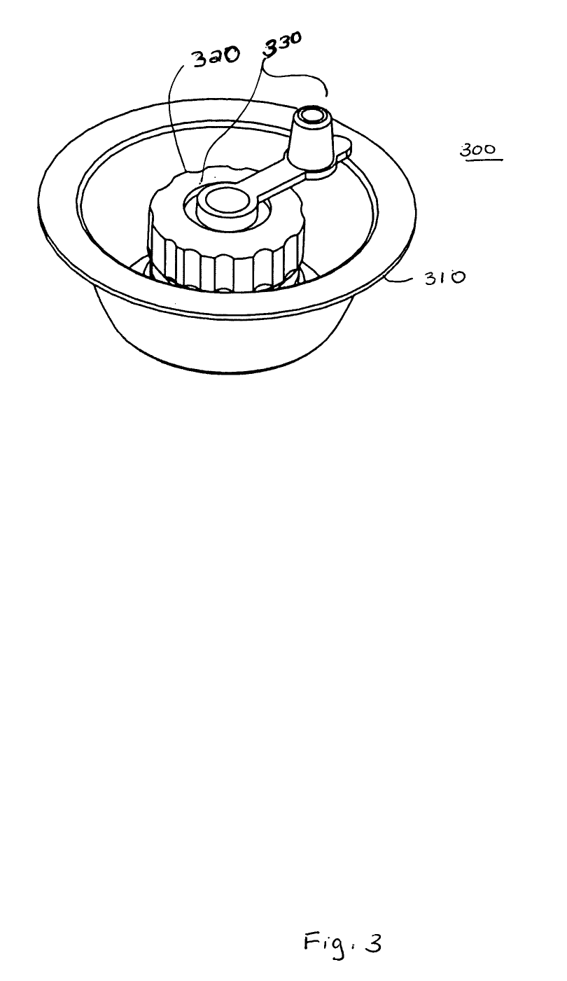

The preferred embodiment of the combination fill and safety valve of the present invention has a one-piece screw valve having a cap that integrally incorporates a modified safety valve with an incorporated inflation/deflation valve stopper replacement. FIG. 3 depicts an assembled embodiment of the combination fill and safety valve of the present invention. In FIG. 3, combination fill and safety valve 300 is comprised of valve cup 310, modified screw cap 320, and advanced safety valve/stopper 330. While in the preferred embodiment modified screw cap 320 and advanced safety valve/stopper 330 are integrally connected, the invention contemplates and includes configurations wherein modified screw cap 320 and advanced safety valve/stopper 330 are separate pieces. When assembled as shown in FIG. 3, advanced safety valve/stopper 330 is inserted into the hole in valve cup 310 and is held in place by modified screw cap 320.

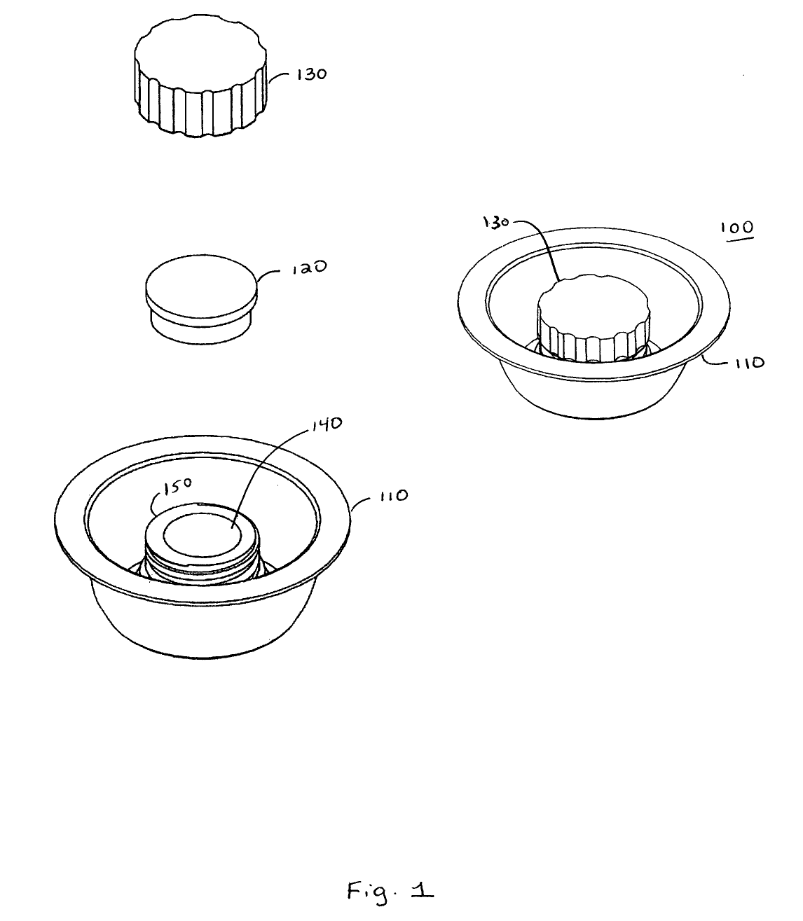

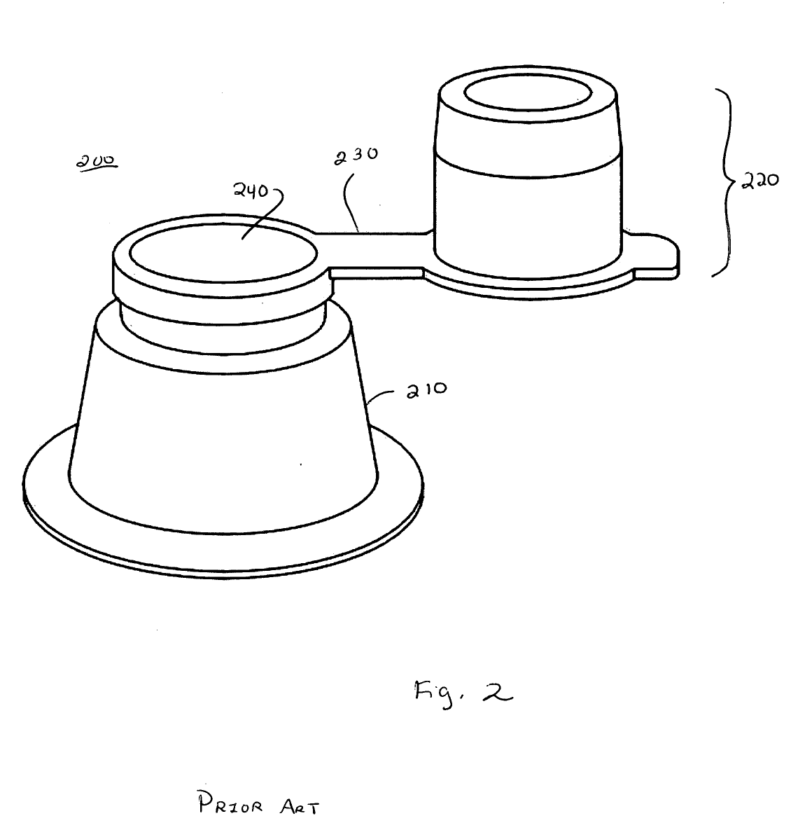

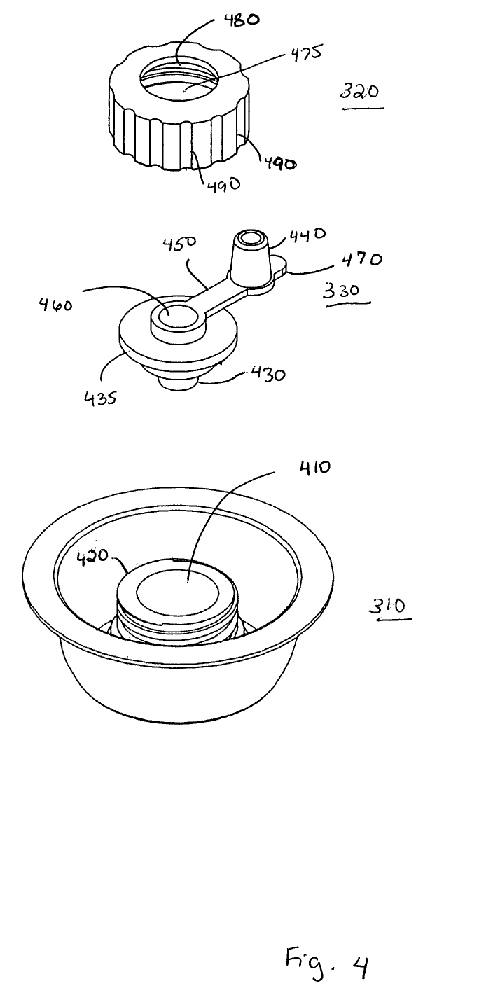

FIG. 4 is an exploded top view of a preferred embodiment of the combination fill and safety valve of the present invention. In FIG. 4, fill valve hole 410 in screw valve chassis 420 of valve cup 310 is configured for receipt of stopper portion 430 of advanced safety valve/stopper 330. The shape of stopper portion 430 is specifically designed to seal valve hole 410 in order to prevent escape of air from the inflatable product. To this end, safety valve/stopper 330 also preferentially has seal portion 435 designed to fit snugly against the lip of valve chassis 420, in order to provide an airtight seal when seal portion 435 is pressed against the lip of valve chassis 420 by the tightening of screw cap 320. Stopper portion 430 and seal portion 435 represent two modifications over the conventional prior art safety valve of FIG. 2, essentially replacing the standard safety valve base with a modification capable of also filling the role of prior art inflation/deflation valve stopper 120 (FIG. 1).

Advanced safety valve/stopper 330 is further comprised of safety cap 440, attached by flexible stem 450 to the circumference of safety valve hole 460, into which safety cap 440 fits snugly when stem 450 is bent, and preferentially includes safety cap release tab 470 for use in removing safety cap 440 from safety valve hole 460. Modified screw cap 320 has screw cap hole 475, through which safety cap 440 and stem 450 protrude, as shown in FIG. 3. Threads 480 of screw cap 320 mate with screw valve chassis 420 and optional edge grooves 490 provide an improved gripping surface when screwing and unscrewing screw cap 320. In the preferred embodiment, modified screw cap 320 and advanced safety valve/stopper 330 are integrally connected, but the invention includes configurations wherein they are separate elements.

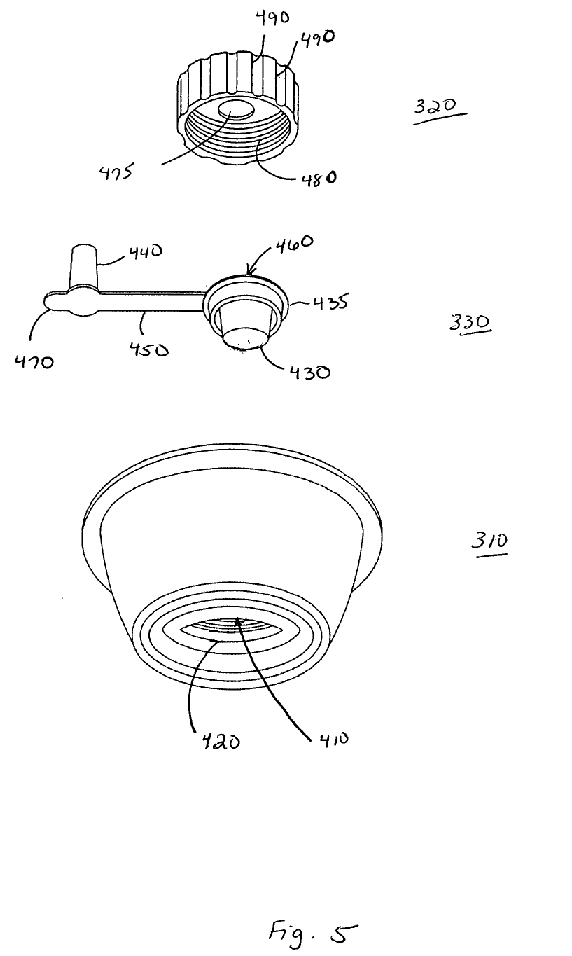

FIG. 5 is an exploded bottom view of a preferred embodiment of the combination fill and safety valve of the present invention. As shown in FIG. 5, valve cup 310 has valve hole 410 surrounded by valve chassis 420. Safety valve/stopper 330 has stopper portion 430, seal portion 435, safety cap 440, stem 450, safety valve hole 460, and safety cap release tab 470. Modified screw cap 320 has screw cap hole 475, threads 480, and optional edge grooves 490.

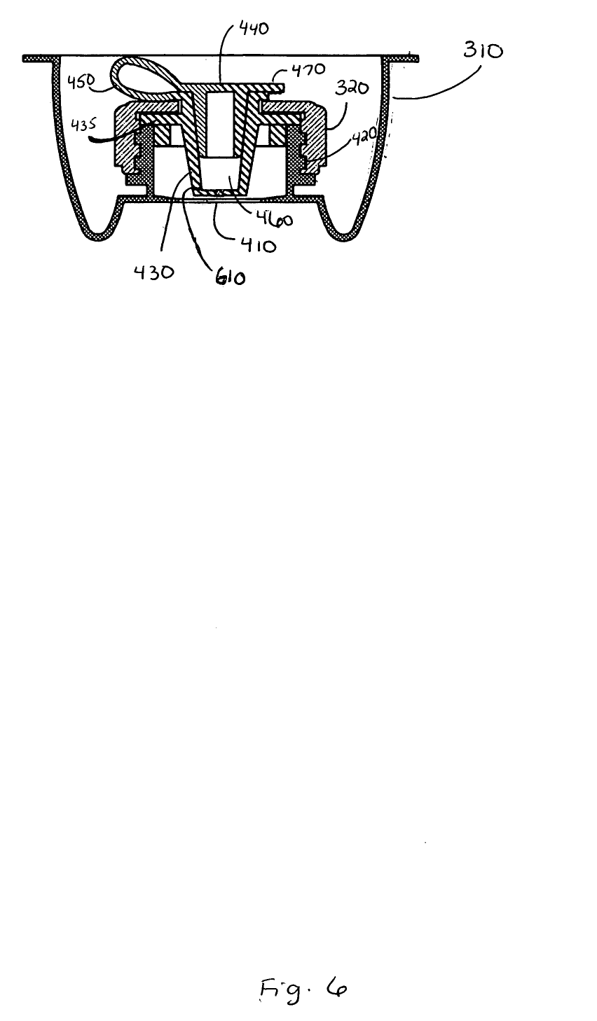

FIG. 6 is a cross section of a preferred embodiment of the assembled combination fill and safety valve of the present invention. In the configuration of FIG. 6, valve cup 310 surrounds the modified safety cap 320 and the attached advanced safety valve/stopper. This is the normal configuration for the combination fill and safety valve of the present invention when the inflatable product is in use. For convenience when the inflatable product is being inflated or deflated, valve cup 310 may be inverted by pulling on safety cap 320, thus pulling the advanced safety valve/stopper out of the well of valve cup 310 for easier access. As shown in FIG. 6, safety valve stopper portion 430 blocks fill valve hole 410 in valve chassis 420, with seal portion 435 resting on the lip of valve chassis 420. Modified screw cap 320 holds seal portion 435 tightly in place against the lip of valve chassis 420, providing an airtight seal. Safety cap 440 is inserted into safety valve hole 460 in stopper potion 430, is attached to stopper portion 430 by stem 450, and may be removed from safety valve hole 460 by use of safety tab 470. In operation as a safety valve, air enters and/or is made to exit the inflatable through check valve 610, which conventionally takes the form of a small slit or aperture in the side of the lower portion of stopper portion 430 but may have any other configuration known in the art.

As shown in FIGS. 3 and 6, the combination fill and safety valve of the present invention is closed and sealed by placing advanced safety valve/stopper 330 into fill valve hole 410 of valve cup 310 and screwing modified screw cap 320 onto valve chassis 420, thereby creating an airtight seal by pressing seal portion 435 of advanced safety valve/stopper 330 against the lip of valve chassis 420 of valve cup 310. Stem 450 and safety cap 440 of advanced safety valve/stopper 330 protrude from screw cap hole 475 in modified screw cap 320 in order to allow for opening and closing of the safety valve.

The combination fill and safety valve of the present invention has two modes of operation, as an inflation/deflation valve and as a safety valve. In the unsealed state, the valve of the present invention may be utilized as a standard inflation/deflation valve. To initiate operation as an inflation/deflation valve, the modified safety cap is unscrewed and the advanced safety valve/stopper is removed from the valve hole in the valve cup, thereby allowing air to be freely passed into and/or out of the inflatable through the valve hole using any method and or mechanism known in the art. In the sealed state, the valve of the present invention may be utilized as a standard inflation/safety valve. To initiate operation as a safety valve, the cap of the advanced safety/valve stopper is removed from the safety valve hole, thereby allowing air to be forced into the inflatable by blowing of air into the safety valve or allowing air to be forcibly removed from the inflatable through adjustment of the internal check valve, possibly also requiring application of pressure to the inflatable.

The combination fill and safety valve of the present invention may be made out of any suitable material known in the art including, but not limited to, those materials known to be suitable for the prior art valves, such as metals, including alloys, plastics, nylon, and composites, such as plastic incorporating carbon fiber, graphite, or carbon Kevlar™. The preferred material is acrylonitrile butadiene styrene resin (ABS). The valve of the present invention may be made by any suitable manufacturing method known in the art including, but not limited to, those methods known to be suitable for manufacturing the prior art inflation/deflation and/or inflation/safety valves, such as extrusion, injection molding, or conventional molding. The preferred method of manufacture is injection molding.

The present invention, therefore, provides a single valve that has both rapid inflation/deflation and safety valve functionality. The valve of the present invention may be manufactured and installed at a lower cost than the two prior art valves, produces a more robust inflatable product, and may reduce the number of steps needed to close and seal an inflation/deflation valve. Each of the various embodiments described above may be combined with other described embodiments in order to provide multiple features. Furthermore, while the foregoing describes a number of separate embodiments of the apparatus and method of the present invention, what has been described herein is merely illustrative of the application of the principles of the present invention. Other arrangements, methods, modifications, and substitutions by one of ordinary skill in the art are therefore also considered to be within the scope of the present invention, which is not to be limited except by the claims that follow.

1. A valve comprising, in combination:
a valve cup having a fill hole; and
a screw valve comprising:
a safety valve, wherein the safety valve is removably inserted into the fill hole to function as a stopper for the fill valve; and
a screw cap.

2. The valve of claim 1, wherein the safety valve and screw cap are integrally connected.

3. The valve of claim 1, wherein the safety valve comprises:
a stopper portion having a check valve; and
a safety cap that is removably insertable into the stopper portion.

4. The valve of claim 3, wherein the safety valve further comprises a seal portion.

5. The valve of claim 2, wherein the safety valve comprises:
a stopper portion having a check valve; and
a safety cap that is removably insertable into the stopper portion.

6. The valve of claim 5, wherein the safety valve further comprises a seal portion.

7. The valve of claim 1, wherein the cap has exterior grooves.

8. The valve of claim 3, wherein the safety cap is attached to the stopper portion by a flexible stem.

9. The valve of claim 3, the safety valve further comprising a safety valve tab.

10. A valve comprising, in combination:
a valve cup, the valve cup having a valve chassis surrounding a fill valve hole;
a stopper, the stopper being removably inserted into the valve hole and comprising a safety valve; and
a cap, the cap being removably screwable onto the valve chassis to secure the stopper in the valve hole and having a hole through which the safety valve may be accessed.

11. The valve of claim 10, wherein the cap is integrally connected to the stopper.

12. The valve of claim 10, wherein the stopper portion has a check valve and the safety valve has a safety cap that is removably insertable into the stopper portion.

13. The valve of claim 10, wherein the stopper further comprises a seal portion.

14. The valve of claim 12, wherein the safety cap is attached to the stopper portion by a flexible stem.

15. A valve comprising, in combination:
a safety valve, the safety valve incorporating a stopper portion;
a valve cup, the valve cup adapted for receiving the stopper portion of the safety valve into a fill valve hole; and
a cap, the cap adapted for securing the safety valve into the fill valve hole.

16. The valve of claim 15, wherein the cap is integrally connected to the safety valve.

17. The valve of claim 15, wherein the safety valve further comprises:
a check valve; and
a safety cap that is removably insertable into the stopper portion.

18. The valve of claim 15, wherein the safety valve further comprises a seal portion.

19. The valve of claim 17, wherein the safety cap is attached to the stopper portion by a flexible stem.

20. The valve of claim 16, wherein the safety valve further comprises:
a check valve; and
a safety cap that is removably insertable into the stopper portion.
